(19) United States
(12) Patent Application Publication
(10) Pub. No.: US 2026/0270253 A1
(43) Pub. Date: Sep. 10, 2026

(54) SYSTEMS AND METHODS FOR REMOTE AUTHENTICATION ACROSS A DISTRIBUTED NETWORK OF DEVICES

(71) Applicant: BANK OF AMERICA CORPORATION, Charlotte, NC (US)

(72) Inventors: Kirk A. Hawrysio, Oak Point, TX (US); Naveen Adala, Charlotte, NC (US); Kevin A. Delson, Woodland Hills, CA (US); Malinda Mae Kieffer, Chillicothe, MO (US); Anne Matrone, Staten Island, NY (US); Noel Arnaldo Medina, Katy, TX (US); Thomas David Morris, Middleburg, FL (US); Pankaj Nagpal, Charlotte, NC (US); Owen Nelson, Farmingdale, NY (US); John David Weber, Lake St. Louis, MO (US); Tanya A. Wilson, Newark, DE (US)

(73) Assignee: BANK OF AMERICA CORPORATION, Charlotte, NC (US)

(21) Appl. No.: 19/072,272

(22) Filed: Mar. 6, 2025

(51) Int. Cl. H04L 9/40

(52) U.S. Cl. CPC H04L 63/083; H04L 63/107; H04L 63/108

(57) ABSTRACT

Systems, computer program products, and methods are described herein for remote authentication across a distributed network of devices. The present disclosure is configured to identify a data transmission request comprising a recipient identifier and a geolocation identifier for a distribution terminal; determine an authentication credential for the data transmission request; receive, at the distribution terminal, an authentication credential input from a recipient user; compare, in response to receiving the authentication credential input, the authentication credential input to the authentication credential; determine the authentication credential input and the authentication credential match; capture, at the distribution terminal, an image of the recipient user in real time or near real time to receiving the authentication credential input; receive, based on the image of the recipient user, an authentication indication of the recipient user; and allow, in response to the authentication indication, the data transmission request for the recipient user at the distribution terminal.

### TECHNOLOGICAL FIELD

Example embodiments of the present disclosure relate to remote authentication across a distributed network of devices.

### BACKGROUND

In today's electronic environment, data transmissions between disparate and remote user devices occur more and more every day. Such data transmissions may be easily misappropriated by man in the middle attacks, eavesdropping, and/or the like. Thus, a system, method, or computer program product that can authenticate a recipient user at the recipient user device before allowing the data transmission to be completed by requiring multiple authentication and security steps across multiple user devices and distribution terminals for the data transmissions.

Applicant has identified a number of deficiencies and problems associated with remote authentication across a distributed network of devices. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for remote authentication across a distributed network of devices.

In one aspect, a system for remote authentication across a distributed network of devices is provided. In some embodiments, the system may comprise: a memory device with computer-readable program code stored thereon; at least one processing device operatively coupled to the memory device and at least one communication device, wherein executing the computer-readable code is configured to cause the at least one processing device to: identify at least one data transmission request, wherein the at least one data transmission request comprises a recipient identifier and a geolocation identifier for a distribution terminal; determine at least one authentication credential for the at least one data transmission request; receive, at the distribution terminal, at least one authentication credential input from a recipient user; compare, in response to receiving the at least one authentication credential input, the at least one authentication credential input to the at least one authentication credential; determine the at least one authentication credential input and the at least one authentication credential match; capture, at the distribution terminal, an image of the recipient user in real time or near real time to receiving the at least one authentication credential input; receive, based on the image of the recipient user, an authentication indication of the recipient user indicating the recipient user is associated with the recipient identifier; and allow, in response to the authentication indication, the data transmission request for the recipient user at the distribution terminal.

In some embodiments, the at least one authentication credential is at least one of a unique string of numbers, a password, an image, or a quick response (QR) code.

In some embodiments, executing the computer-readable code is configured to cause the at least one processing device to: generate, by a sender user device, the data transmission request; and transmit, by the sender user device, the data transmission request to the distribution terminal associated with the geolocation identifier.

In some embodiments, executing the computer-readable code is configured to cause the at least one processing device to: transmit the at least one authentication credential from a sender user device to a recipient user device associated with the recipient identifier.

In some embodiments, executing the computer-readable code is configured to cause the at least one processing device to: transmit, from the distribution terminal, the image of the recipient user to a sender user device; and receive, from the sender user device and in response to the transmission of the image, an authentication indication of the recipient user, wherein the authentication indication comprises a positive authentication of the recipient user.

In some embodiments, the data transmission request comprises a time limit, and wherein the time limit is based on a start time at a generation of the data transmission request or at the identification of the data transmission request, and an end time indicated by the time limit. In some embodiments, executing the computer-readable code is configured to cause the at least one processing device to: compare a timestamp of the at least one authentication credential input to the time limit; and cause, in an instance where the authentication credential input time is within the time limit, the comparison of the at least one authentication credential input to the at least one authentication credential. In some embodiments, executing the computer-readable code is configured to cause the at least one processing device to: compare a timestamp of the at least one authentication credential input to the time limit; and automatically reject, in an instance where the authentication credential input time is outside the time limit, the authentication credential input, wherein an automatic rejection comprises the blocking of the data transmission request.

In some embodiments, the recipient identifier comprises at least one of a username, a phone number, a unique string of characters, a physical characteristic, or an image.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for remote authentication across a distributed network of devices rces, in accordance with an embodiment of the disclosure;

FIG. 2 illustrates a process flow for remote authentication across a distributed network of devices, in accordance with an embodiment of the disclosure;

FIG. 3 illustrates a process flow for generating and transmitting the data transmission request, in accordance with an embodiment of the disclosure;

FIG. 4 illustrates a process flow for transmitting the authentication credential from a sender user device to a recipient user device, in accordance with an embodiment of the disclosure;

FIG. 5 illustrates a flow diagram for transmitting an image of the recipient user and receiving an authentication indication of the recipient user, in accordance with an embodiment of the disclosure; and

FIG. 6 illustrates a flow diagram for determining whether the authentication credential input received within a time limit, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

In today's electronic environment, data transmissions between disparate and remote user devices occur more and more every day. Such data transmissions may be easily misappropriated by man in the middle attacks, eavesdropping, and/or the like. Thus, a system, method, or computer program product that can authenticate a recipient user at the recipient user device before allowing the data transmission to be completed by requiring multiple authentication and security steps across multiple user devices and distribution terminals for the data transmissions.

Accordingly, the present disclosure identifies at least one data transmission request, wherein the at least one data transmission request comprises a recipient identifier and a geolocation identifier for a distribution terminal; determines at least one authentication credential for the at least one data transmission request; receives, at the distribution terminal, at least one authentication credential input from a recipient user; and compares, in response to receiving the at least one authentication credential input, the at least one authentication credential input to the at least one authentication credential. Further, the disclosure determines the at least one authentication credential input and the at least one authentication credential match; captures, at the distribution terminal, an image of the recipient user in real time or near real time to receiving the at least one authentication credential input; receives, based on the image of the recipient user, an authentication indication of the recipient user indicating the recipient user is associated with the recipient identifier; and allows, in response to the authentication indication, the data transmission request for the recipient user at the distribution terminal.

In other words, the disclosure provides a system for remote authentication of users at different devices, such as resource distribution terminals (e.g., ATMs and other such distribution terminals), based on at least two levels of security and authentication. For instance, a sender of the resource distribution may identify a recipient user using one or more identifying data input at a sender user device (e.g., recipient name, location, phone number, account identifier, and/or the like) and identify a recipient geolocation of a distribution terminal. Additionally, and based on this identifying data and distribution terminal, the system may generate an authentication credential (e.g., QR code, PIN, and/or the like) for the sender to send to the intended recipient for a secure first authentication step. Upon arriving at the intended distribution terminal, the recipient may input the authentication credential, which may be automatically and in real time or near real time validated by the system. Upon validating the authentication credential, the distribution terminal will be configured to take a real time picture of the recipient and will automatically transmit this image to a user device associated with the sender for further confirmation before the resource distribution is completed.

What is more, the present disclosure provides a technical solution to a technical problem. As described herein, the technical problem includes the authentication of user devices and users associated with the user devices for remote data transmission across a distributed network of devices. The technical solution presented herein allows for the remote authentication across a distributed network of devices via multiple security and authentication steps across the devices and network communications between a plurality of devices to allow real time or near real time data transmissions. In particular, the disclosure provided herein is an improvement over existing solutions to the remote authentication across a distributed network of devices, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

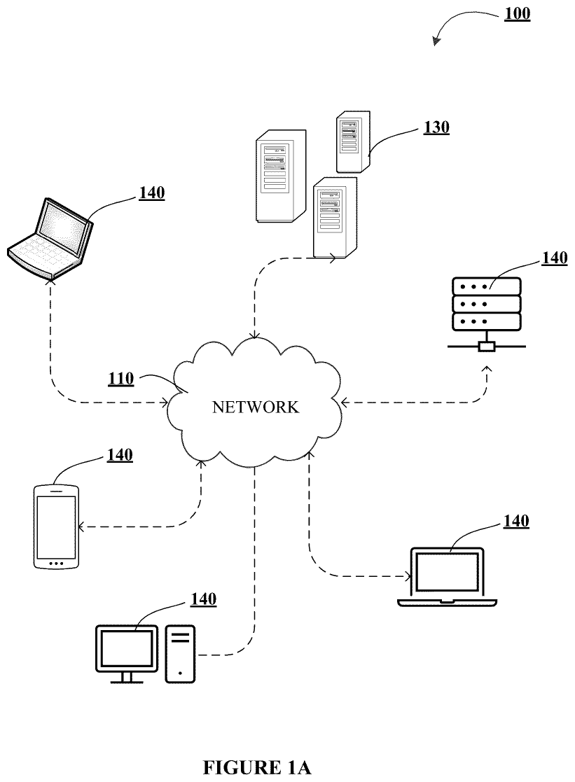

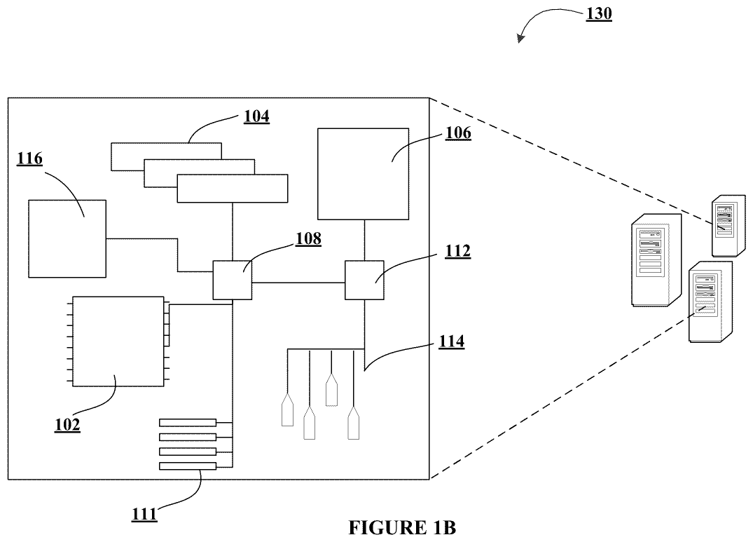

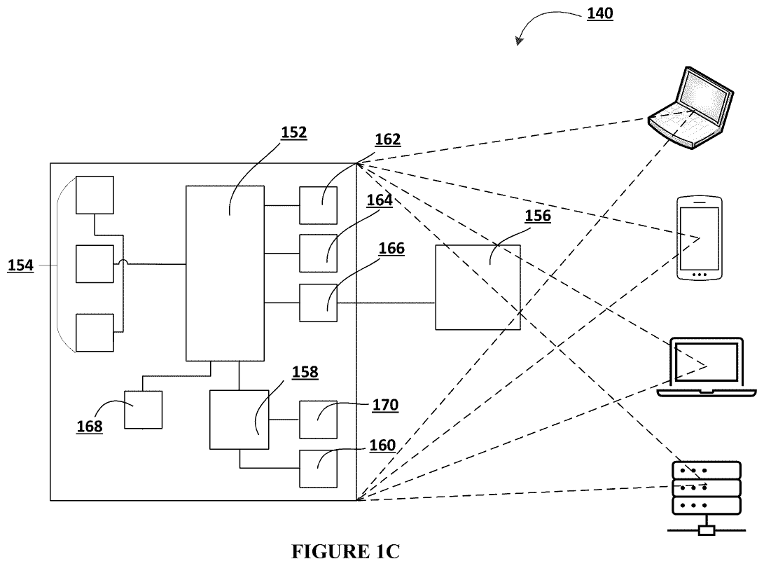

FIGS. 1A-1C illustrate technical components of an exemplary distributed computing environment for remote authentication across a distributed network of devices 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

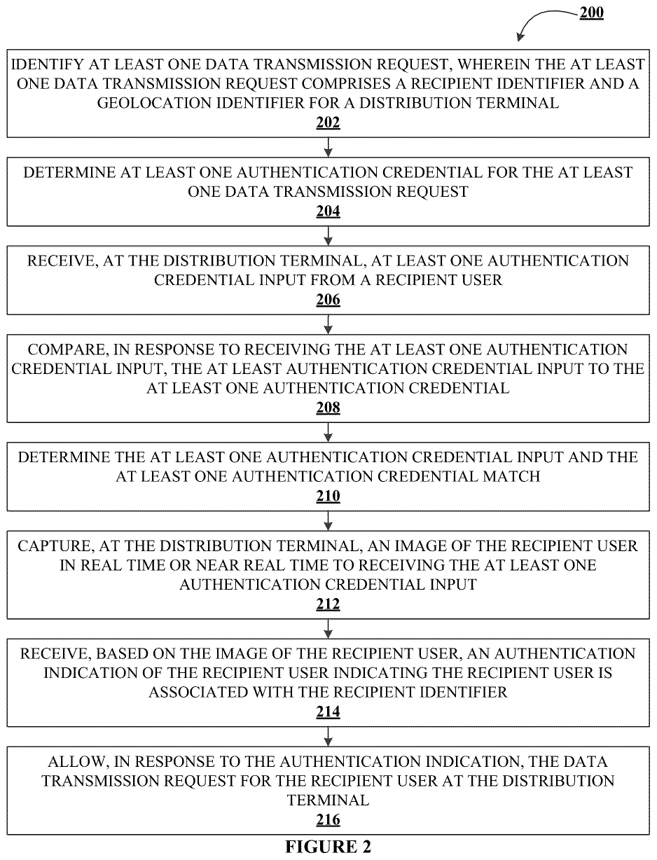

FIG. 2 illustrates a process flow 200 for remote authentication across a distributed network of devices, in accordance with an embodiment of the disclosure. In some embodiments, a system (e.g., similar to one or more of the systems described herein with respect to FIGS. 1A-1C) may perform one or more of the steps of process flow 200. For example, a system (e.g., the system 130 described herein with respect to FIG. 1A-1C) may perform the steps of process 200.

As shown in block 202, the process flow 200 may include the step of identifying at least one data transmission request, wherein the at least one data transmission request comprises a recipient identifier and a geolocation identifier for a distribution terminal. For instance, the data transmission request may comprise information regarding the data that may be transmitted from a sender user account (or resource account) to a recipient user. For example, and in some embodiments, the data that may be transmitted may comprise resources or an amount of resources that will be transmitted from a sender resource account (e.g., a bank account, a credit account, and/or the like) that the recipient user may be access upon meeting the security and authentication requirements described herein.

In some embodiments, the system may identify the data transmission request by receiving the data transmission request from a sender user device (e.g., a sender's mobile device, personal computer, tablet, and/or the like), which may have generated the data transmission request and transmitted the data transmission request to the system via a network. In some embodiments, the data transmission request may be received by a distribution terminal comprising the system described herein. For example, and in some embodiments, the system may be embedded within the distribution terminal, operatively coupled to the distribution terminal, separately stored and housed but connected (via a network or wired connection) to the distribution terminal. Thus, and in some embodiments, the system may identify the receipt of the data transmission request at the system itself and/or at the distribution terminal.

In some embodiments, the data transmission request may be generated initially by a recipient user device (such as the intended recipient of the data transmission or resource amount in the data transmission request), and the recipient user device may transmit the data transmission request to the sender user device via a network. Further, and in some such embodiments, the sender user device, upon receiving the data transmission request, may configure its graphical user interface to show the data of the data transmission request and request an input accepting or rejecting the data transmission request. In some embodiments, and where the sender user accepts the data transmission request, the data transmission request may be automatically transmitted to the system at the identified geolocation associated with the distribution terminal and/or transmitted to the distribution terminal identified by the geolocation identifier.

In some embodiments, the geolocation identifier described herein may be used to uniquely identify a distribution terminal (or a plurality of distribution terminals associated with the same geolocation identifier) in the world. For example, and in some embodiments, the distribution terminal described herein may comprise a resource distribution terminal such as but not limited to a point of sale device, an automated teller machine (ATM), and/or the like. Thus, and in some embodiments, the geolocation identifier may comprise geolocation coordinates of a financial institution's branch or brick and mortar location, a geolocation where a distribution terminal is present and operational (e.g., such as a distribution terminal at a store's brick and mortar location, a point of sale device at a store, bank, cash checking storefront, and/or the like). Thus, and based on the geolocation identifier, a distribution terminal (or a plurality of distribution terminals) that may be used to complete the data transmission terminal may be identified and may receive the data transmission request for a future resource distribution.

In some embodiments, the recipient identifier may comprise at least one of a username, a phone number, a unique string of characters, a physical characteristic(s) (e.g., a fingerprint of the intended recipient user, an eye scan of the recipient user, and/or the like), an image (e.g., a picture of the recipient user, and/or the like), and/or the like.

As shown in block 204, the process flow 200 may include the step of determining at least one authentication credential for the at least one data transmission request. For instance, the authentication credential(s) for the data transmission request may be unique to the data transmission request and may be randomly generated by the system, by a sender user, a combination of the sender user and the recipient user, and/or the like. Thus, and as described herein, the authentication credential(s) may comprise a system-generated and/or sender user-generated input that must be entered to the distribution terminal in order to allow the data transmission request to be completed. For example, and where the authentication credential is a QR code, the system may require the exact match of the QR code to be input to the distribution terminal by the recipient user to continue the process of authenticating the user and, in an instance where the recipient user meets all the requirements, allowing the data transmission request. In some embodiments, the at least one authentication credential is at least one of a unique string of numbers (e.g., a PIN), a password, an image, a quick response (QR) code, a physical characteristic, and/or the like.

In some embodiments, the authentication credential(s) may be determined by the system based on receiving the authentication credential(s) from the sender user account, determined based on generating—by the system—the authentication credential(s), and/or the like. Thus, and as used herein, this authentication credential(s) may be used by the system to authentication a recipient user when a recipient user may not have another form of identification, or another method to authenticate themselves.

As shown in block 206, the process flow 200 may include the step receiving, at the distribution terminal, at least one authentication credential input from a recipient user. Thus, and based on the recipient user inputting the correct (matching) authentication credential input that matches authentication credential(s) determined by the system, the system may verify the recipient user is the recipient user intended by the sender user. By way of non-limiting example, a sender user and/or the system itself may generate a unique PIN, unique QR code, unique passcode, and/or the like, which may then be transmitted to the intended recipient user (such as over a network to the recipient user's phone as a text message, as an instant, secure message on an application within the recipient's phone, and/or the like). Further, and upon receiving the authentication credential(s), the recipient user may input the authentication credential(s) at the distribution terminal, which may further be configured to capture an image of the recipient user in real time or near real time to the recipient user inputting the authentication credential input. Thus, and in some embodiments, upon confirming the authentication credential input matches the authentication credential(s), the system may capture an image of the recipient user and transmit the image to the sender user device for further verification.

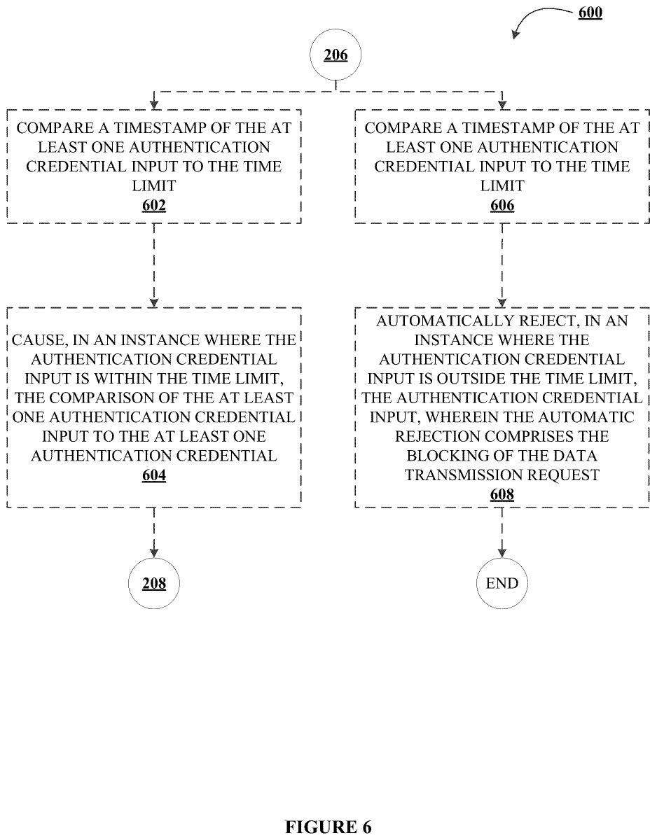

In some embodiments, the authentication credential(s) may have a time limit to be shown at the recipient user's device. For instance, and where the time limit has been met, the system may automatically delete or cause a deletion of the authentication credential(s) at the recipient user device. In some embodiments, the system—upon the time limit being met or exceeded—may automatically block any further inputs by the recipient user at the distribution terminal upon determining the authentication credential input matches an authentication credential(s) associated with a data transmission request that has expired. Thus, and in some such embodiments, the system may automatically block the data transmission request from being completed. Such an embodiment is described in further detail below with respect to FIG. 6.

As shown in block 208, the process flow 200 may include the step of comparing, in response to receiving the at least one authentication credential input, the at least one authentication credential input to the at least one authentication credential. For instance, the system may determine the similarities and differences between the authentication credential(s) and the authentication credential input received at the distribution terminal. Such a comparison may comprise a one to one comparison, where if there is even a slight difference between the authentication credential and the authentication credential input is determined, the system will determine that the authentication credential does not match the authentication credential. For instance, and where the authentication credential is a QR code and the authentication credential input is a QR code that comprises 99% of the same pixels in the same positions, but one pixel is different between the authentication credential QR code and the authentication credential input QR code, then the system may determine the authentication credential and the authentication credential input do not match and may block any further inputs by the recipient user.

Thus, and in other words, the system may require that the authentication credential input is an exact match to the authentication credential (e.g., the sequence of characters, numbers, and/or the like, or the images and their individual pixel placements and colors) are an exact match.

In some embodiments, and where the authentication credential input is not an exact match, the system may configure the graphical user interface of the distribution terminal to request the recipient user re-input the authentication credential input. Thus, and in some embodiments, the system may allow multiple attempts of the authentication credential input until an exact match is determined. In some embodiments, the number of attempts allowed may be limited by the system itself, by the sender user associated with the data transmission request, and/or by a combination of the system and sender user.

As shown in block 210, the process flow 200 may include the step of determining the at least one authentication credential input and the at least one authentication credential match. For example, and as described briefly above, the matching of the at least one authentication credential input to the at least one authentication credential may be determined by a one-to-one comparison of each character, number, pixel, physical characteristic, and/or the like. By way of non-limiting example, and in an instance where the authentication credential is an image (such as a QR code or an image of a person, animal, landscape, and/or the like), the system may compare each pixel, each color at each pixel, each width and/or height of each pixel, when comparing the authentication credential input to the authentication credential. By way of non-limiting example, and where the authentication credential is a PIN (or sequence of numbers), the system may compare each number in the sequence at each position to the authentication credential input's numbers and positions, and determine if the authentication credential and the authentication credential input exactly match.

As shown in block 212, the process flow 200 may include the step of capturing, at the distribution terminal, an image of the recipient user in real time or near real time to receiving the at least one authentication credential input. For example, the system may capture an image of the recipient user using the distribution terminal, where the distribution terminal may be configured with a camera or image-capturing device, and/or by a camera operatively coupled to the distribution terminal. In some embodiments, an image of the recipient at the distribution terminal may be captured in real time or near real time to the recipient user inputting the authentication credential input.

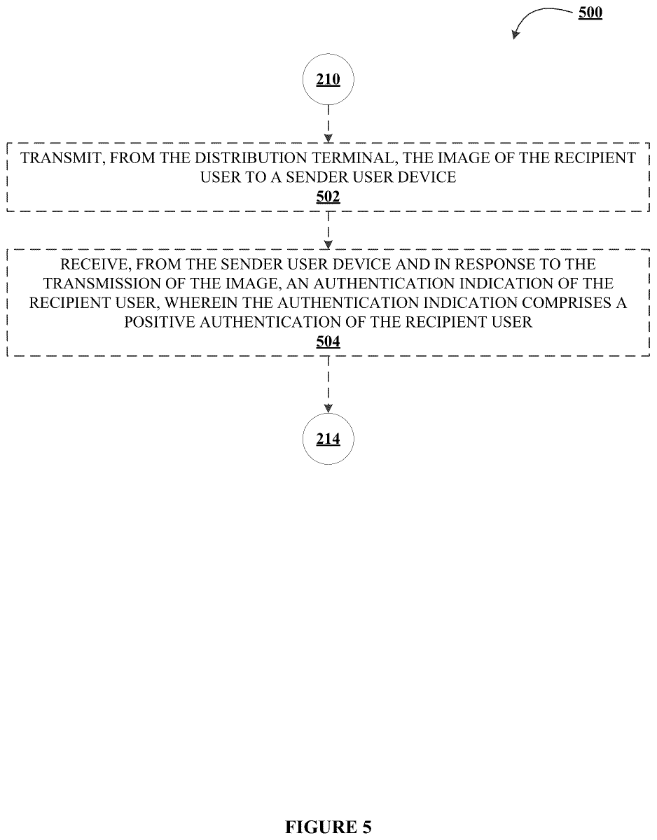

Additionally, and/or alternatively, the image may be captured immediately after the user inputs the authentication credential input and/or immediately after the authentication credential input is determined as a match to the authentication credential. Thus, and in some embodiments, upon the system determining the authentication credential input matches the authentication credential, the system may identify the data transmission request the authentication credential input corresponds to and thus, identify the sender user device associated with the data transmission request. Upon determining the sender user device, and in some such embodiments, the system may automatically trigger a transmission of the image of the recipient user to the sender user device for further confirmation the recipient user at the distribution terminal is the intended recipient user that should receive the data transmission (e.g., the resource transmission). Such an embodiment is further described below with respect to FIG. 5.

As shown in block 214, the process flow 200 may include the step of receiving, based on the image of the recipient user, an authentication indication of the recipient user indicating the recipient user is associated with the recipient identifier. For example, such an authentication credential may indicate that the recipient user is authenticated as the intended recipient user by the authentication indication comprising a positive indication. In some embodiments, and where the authentication indication comprises a negative indication, the system may determine the recipient user at the distribution terminal is not the intended recipient user for the data transmission request, and thus, the data transmission request shall be blocked for the recipient user.

In some embodiments, the system itself may generate the authentication indication by comparing an image of the intended recipient user (which may have been received with the data of the data transmission request) to the image of the recipient user at the distribution terminal. In some such embodiments, the system may be configured with facial recognition software to compare the image of the recipient user to the image of the intended recipient user to determine if there is a match or not a match.

Additionally, and/or alternatively, the sender user may generate the authentication indication by interacting with their sender user device and inputting the authentication indication upon reviewing the image of the recipient user. Thus, and in some such embodiments, the sender user may view the image transmitted from the system or the distribution terminal at the sender user device's graphical user interface, and the graphical user interface may be configured with selectable icons for the sender user to indicate a positive indication or negative indication regarding the recipient user's match with the intended recipient user. Such an embodiment is described in further detail hereinbelow with respect to FIG. 5.

As shown in block 216, the process flow 200 may include the step of allowing, in response to the authentication indication, the data transmission request for the recipient user at the distribution terminal. Thus, the system may—based on receiving an authentication indication of the recipient user—allow the data transmission request to be completed for the recipient user. For example, the system may allow—in an instance where the recipient user at the distribution terminal is indicated as the intended recipient user in the authentication indication—the data transmission request to be completed. For instance, and in such an embodiment, the system may allow the data transmission request to be completed at the distribution terminal, which may comprise allowing a resource distribution indicated by the data transmission request (e.g., the resource amount in the data transmission request) to the recipient user at the distribution terminal in real time or near real time to receiving the authentication indication.

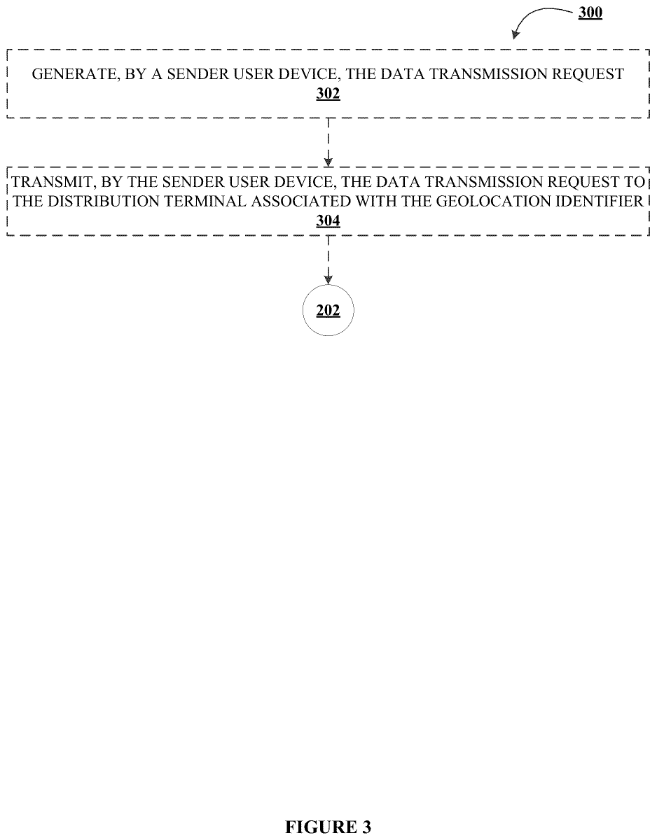

FIG. 3 illustrates a process flow 300 for generating and transmitting the data transmission request, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300.

In some embodiments, and as shown in block 302, the process flow 300 may include the step of generating, by a sender user device, the data transmission request. In some embodiments, the data transmission request may be initially generated by the sender user at the sender user device. In some embodiments, the data transmission request may be initially generated by the recipient user device, transmitted to the sender user device (such as over a network, via a text message, an instant message, an application message, and/or the like), and then upon an affirmation or user input indicating the sender user accepts the data transmission request, the system may identify the sender user's acceptance of the data transmission request and may start the process described hereinabove with respect to FIG. 2.

In some embodiments, and as shown in block 304, the process flow 300 may include the step of transmitting, by the sender user device, the data transmission request to the distribution terminal associated with the geolocation identifier. Thus, and in some such embodiments, the system may transmit—from the sender user device—the data transmission request itself and/or an acceptance of the data transmission request. For example, the data transmission request may be transmitted from the sender user device based on the sender user inputting the data of the data transmission request into the sender user device and/or the sender user inputting an acceptance of the data transmission request generated by the intended recipient user and transmitted from the intended recipient user device. In both embodiments, the system may receive data from the sender user device, and the system may extract data from the data transmission request to determine what data (e.g., an amount of a resource) to transmit to the intended recipient user to extract from an identified distribution terminal.

Additionally, and in some embodiments, the process described herein with respect to FIG. 3 may occur before the process described herein with respect to block 202.

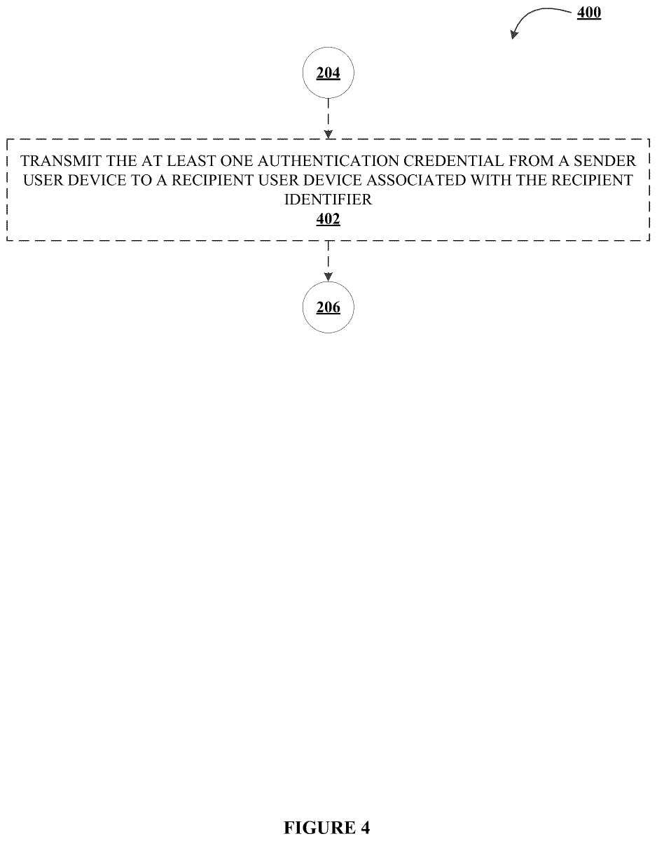

FIG. 4 illustrates a process flow 400 for transmitting the authentication credential from a sender user device to a recipient user device, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400.

In some embodiments, and as shown in block 402, the process flow 400 may include the step of transmitting the at least one authentication credential from a sender user device to a recipient user device associated with the recipient identifier. For instance, the system may transmit the authentication credential from a sender user device to the recipient user device. Thus, and in some embodiments, the system itself may automatically trigger the transmission of the authentication credential from the sender user device to the recipient user device.

In some embodiments, the system may itself transmit the authentication credential to the recipient user device, and the system may determine the recipient user device based on the recipient identifier determined from the data transmission request which originally identified the intended recipient. For example, and where the system generates the authentication credential(s) and/or where a combination of the system and the sender user generates the authentication credential(s), the system may automatically transmit the authentication credential(s) to the recipient user device. In some embodiments, the system may additionally transmit the authentication credential(s) to the sender user device for further review and another copy of the authentication credential that is readily available. Thus, and in an instance where the recipient user device may have deleted the authentication credential(s) or where the recipient user device is non-operable, the sender user device may transmit the authentication credential(s) to the recipient user device and/or to another recipient user device.

In some embodiments, the sender user may transmit the authentication credential from the sender user device to the intended recipient user device. Thus, and upon determining the authentication credential(s) that the intended recipient user will need to match with their authentication credential input, the sender user device may automatically transmit the authentication credential(s) to the intended recipient's user device. Such a transmission may comprise a text message, an email, an instant message, a message within an application on both the sender user device and the intended recipient user device, and/or the like.

Additionally, and in some embodiments, the process described herein with respect to FIG. 4 may occur after the process described herein with respect to block 204 and/or before the process described herein with respect to block 206.

FIG. 5 illustrates a process flow 500 for transmitting an image of the recipient user and receiving an authentication indication of the recipient user, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500.

In some embodiments, and as shown in block 502, the process flow 500 may include the step of transmitting, from the distribution terminal, the image of the recipient user to a sender user device. For example, and in some such embodiments, the system may transmit—from the distribution terminal—the image of the recipient user at the distribution terminal currently to the sender user device that generated, transmitted, and/or is associated with the data transmission request. In some such embodiments, the system may transmit the image of the recipient user over a network to the same sender user device associated with the data transmission request upon the authentication credential input being received and matched to the authentication credential of the data transmission request. Thus, the system may identify which data transmission request the recipient user is attempting to access and complete, and upon this identification, the system may transmit the image to the associated sender user device. In some embodiments, the image may be captured in real time or near real time to the authentication credential input being received at the distribution terminal, and upon matching the authentication credential input being matched to an authentication credential, the system may automatically trigger the transmission of the image to the associated sender user device.

In some embodiments, and as shown in block 504, the process flow 500 may include the step of receiving, from the sender user device and in response to the transmission of the image, an authentication indication of the recipient user, wherein the authentication indication comprises a positive authentication of the recipient user. For example, the system may receive—from the sender user device and based on the transmission of the image—an authentication indication from the sender user device.

In some embodiments, the authentication indication may comprise a positive indication (i.e., indicating the recipient user at the distribution terminal is the intended recipient for the data transmission request) or a negative indication (i.e., indicating the recipient user at the distribution terminal is not the intended recipient for the data transmission request). In some embodiments, the sender user device may receive a user input at its graphical user interface, and the interaction at the graphical user interface may be at a selectable icon for a positive indication or a selectable icon for a negative indication.

Additionally, and in some embodiments, the process described herein with respect to FIG. 5 may occur after the process described herein with respect to block 210 and/or before the process described herein with respect to block 214.

FIG. 6 illustrates a process flow 600 for determining whether the authentication credential input received within a time limit, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process 600.

In some embodiments, the data transmission request may comprise a time limit, and the time limit may be based on a start time at a generation of the data transmission request or at the identification of the data transmission request, and an end time may be indicated by the time limit. Thus, and in other words, the system may determine a start time for the data transmission request and an end time as the time the data transmission request was attempted to be completed. In some such embodiments, the system may compare the start time and end time to the time limit to determine if the start time and the end time is within the time limit or meets the time limit (e.g., is allowable to be completed), or whether the start time and end time is outside the time limit (e.g., is not allowable to be completed). Thus, and in some such embodiments, the system may be limited with a temporal limit as part of an authentication security requirement where a user only has a limited amount of time after data transmission request is generated and/or determined by the system or distribution terminal.

In some embodiments, and as shown in block 602, the process flow 600 may include the step of comparing a timestamp of the at least one authentication credential input to the time limit. For example, the system may compare the timestamp of the authentication credential input received at the distribution terminal to the time limit, where such a time limit may be pre-determined by the system itself (e.g., based on past instances of misappropriation attempts and their associated timestamps as compared to the start times of generating or determining the authentication credential(s)), by the sender user (e.g., may be customizable to the sender user account and/or customizable to each data transmission request), by a combination of the sender user and the system, and/or the like.

Thus, and in some such embodiments, the length of time between the start time for the data transmission request and the end time that the data transmission request was attempted to be completed, and this length of time may be compared to the time limit. For example, and where the start time (e.g., the time which the data transmission request was generated) was 11:30 am EST by a sender user on the east coast of the United States, and the data transmission request has a time limit of 24 hours, then the intended recipient user has until 11:30 am EST the next day to input the authentication credential input at the identified distribution terminal. In some embodiments, such a time limit may be independent of the time zone of the distribution terminal (e.g., where the distribution terminal is located across the world and/or in a different time zone than sender user device, the time limit may not change based on the time zone of the distribution terminal.

In some embodiments, and as shown in block 604, the process flow 600 may include the step of causing, in an instance where the authentication credential input is within the time limit, the comparison of the at least one authentication credential input to the at least one authentication credential. For example, the system may compare the start time and end time to the time limit, and the system may determine if the length of time between the start time and end time meets or is less than the time limit. In an instance where the length of time is less than or meets the time limit, the system may automatically cause the comparison of the credential input to the at least one authentication credential. Thus, and in other words, where the length of time is within the time limit, the system may continue the process described above with respect to FIG. 2 at block 208.

In contrast, and in an instance where the length of time is not within the time limit, the system may automatically block or reject the process described herein with respect to FIG. 2 upon receiving the authentication credential input. Such an embodiment is described below.

In some embodiments, and as shown in block 606, the process flow 600 may include the step of comparing a timestamp of the at least one authentication credential input to the time limit. As a person of skill in the art would understand, the process described herein may be similar to the process described above with respect to comparing the timestamp of the at least one authentication credential input to the time limit by comparing the length of time to the time limit.

In some embodiments, and as shown in block 608, the process flow 600 may include the step of automatically rejecting, in an instance where the authentication credential input is outside the time limit, the authentication credential input, wherein the automatic rejection comprises the blocking of the data transmission request. For instance, the system may determine the length of time exceeds the time limit. In such an instance, the system may automatically reject and/or block the data transmission request from being completed by rejecting the authentication credential input in real time or near real time to the recipient user inputting the authentication credential input. Thus, and in some embodiments, where the time limit has been exceeded when the data transmission request is attempted, the system may automatically block the data transmission request and not allow further inputs by the recipient user at the distribution terminal with respect to the data transmission request.

In some embodiments, the automatic rejection of the authentication credential input may further comprise a transmission of an alert to the sender user device indicating the data transmission request was blocked. Such an alert may automatically configure the graphical user interface of the sender user device. In some embodiments, the alert may comprise a request for input by the sender user to indicate whether the sender would like to re-start the time limit for the data transmission request. In such an embodiment, and where the sender user restarts the time limit, the processes described herein may occur until the data transmission request is completed.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for remote authentication across a distributed network of devices, the system comprising:
a memory device with computer-readable program code stored thereon;
at least one processing device operatively coupled to the memory device and at least one communication device, wherein executing the computer-readable code is configured to cause the at least one processing device to:
identify at least one data transmission request, wherein the at least one data transmission request comprises a recipient identifier and a geolocation identifier for a distribution terminal;
determine at least one authentication credential for the at least one data transmission request;
receive, at the distribution terminal, at least one authentication credential input from a recipient user;
compare, in response to receiving the at least one authentication credential input, the at least one authentication credential input to the at least one authentication credential;
determine the at least one authentication credential input and the at least one authentication credential match;
capture, at the distribution terminal, an image of the recipient user in real time or near real time to receiving the at least one authentication credential input;
receive, based on the image of the recipient user, an authentication indication of the recipient user indicating the recipient user is associated with the recipient identifier; and
allow, in response to the authentication indication, the data transmission request for the recipient user at the distribution terminal.

2. The system of claim 1, wherein the at least one authentication credential is at least one of a unique string of numbers, a password, an image, or a quick response (QR) code.

3. The system of claim 1, wherein executing the computer-readable code is configured to cause the at least one processing device to:
generate, by a sender user device, the data transmission request; and
transmit, by the sender user device, the data transmission request to the distribution terminal associated with the geolocation identifier.

4. The system of claim 1, wherein executing the computer-readable code is configured to cause the at least one processing device to:
transmit the at least one authentication credential from a sender user device to a recipient user device associated with the recipient identifier.

5. The system of claim 1, wherein executing the computer-readable code is configured to cause the at least one processing device to:
transmit, from the distribution terminal, the image of the recipient user to a sender user device; and
receive, from the sender user device and in response to the transmission of the image, an authentication indication of the recipient user, wherein the authentication indication comprises a positive authentication of the recipient user.

6. The system of claim 1, wherein the data transmission request comprises a time limit, and wherein the time limit is based on a start time at a generation of the data transmission request or at the identification of the data transmission request, and an end time indicated by the time limit.

7. The system of claim 6, wherein executing the computer-readable code is configured to cause the at least one processing device to:
compare a timestamp of the at least one authentication credential input to the time limit; and
cause, in an instance where the authentication credential input time is within the time limit, the comparison of the at least one authentication credential input to the at least one authentication credential.

8. The system of claim 6, wherein executing the computer-readable code is configured to cause the at least one processing device to:
compare a timestamp of the at least one authentication credential input to the time limit; and
automatically reject, in an instance where the authentication credential input time is outside the time limit, the authentication credential input, wherein an automatic rejection comprises the blocking of the data transmission request.

9. The system of claim 1, wherein the recipient identifier comprises at least one of a username, a phone number, a unique string of characters, a physical characteristic, or an image.

10. A computer program product for remote authentication across a distributed network of devices, wherein the computer program product comprises at least one non-transitory computer-readable medium having computer-readable program code portions embodied therein, the computer-readable program code portions which when executed by a processing device are configured to cause the processor to:
identify at least one data transmission request, wherein the at least one data transmission request comprises a recipient identifier and a geolocation identifier for a distribution terminal;
determine at least one authentication credential for the at least one data transmission request;
receive, at the distribution terminal, at least one authentication credential input from a recipient user;
compare, in response to receiving the at least one authentication credential input, the at least one authentication credential input to the at least one authentication credential;
determine the at least one authentication credential input and the at least one authentication credential match;
capture, at the distribution terminal, an image of the recipient user in real time or near real time to receiving the at least one authentication credential input;
receive, based on the image of the recipient user, an authentication indication of the recipient user indicating the recipient user is associated with the recipient identifier; and
allow, in response to the authentication indication, the data transmission request for the recipient user at the distribution terminal.

11. The computer program product of claim 10, wherein the at least one authentication credential is at least one of a unique string of numbers, a password, an image, or a quick response (QR) code.

12. The computer program product of claim 10, wherein the computer-readable program code portions which when executed by the processing device are configured to cause the processor to:
generate, by a sender user device, the data transmission request; and
transmit, by the sender user device, the data transmission request to the distribution terminal associated with the geolocation identifier.

13. The computer program product of claim 10, wherein the computer-readable program code portions which when executed by the processing device are configured to cause the processor to:
transmit the at least one authentication credential from a sender user device to a recipient user device associated with the recipient identifier.

14. The computer program product of claim 10, wherein the computer-readable program code portions which when executed by the processing device are configured to cause the processor to:
transmit, from the distribution terminal, the image of the recipient user to a sender user device; and
receive, from the sender user device and in response to the transmission of the image, an authentication indication of the recipient user, wherein the authentication indication comprises a positive authentication of the recipient user.

15. The computer program product of claim 10, wherein the data transmission request comprises a time limit, and wherein the time limit is based on a start time at a generation of the data transmission request or at the identification of the data transmission request, and an end time indicated by the time limit.

16. A computer implemented method for remote authentication across a distributed network of devices, the computer implemented method comprising:
identifying at least one data transmission request, wherein the at least one data transmission request comprises a recipient identifier and a geolocation identifier for a distribution terminal;
determining at least one authentication credential for the at least one data transmission request;
receiving, at the distribution terminal, at least one authentication credential input from a recipient user;
comparing, in response to receiving the at least one authentication credential input, the at least one authentication credential input to the at least one authentication credential;
determining the at least one authentication credential input and the at least one authentication credential match;
capturing, at the distribution terminal, an image of the recipient user in real time or near real time to receiving the at least one authentication credential input;
receiving, based on the image of the recipient user, an authentication indication of the recipient user indicating the recipient user is associated with the recipient identifier; and
allowing, in response to the authentication indication, the data transmission request for the recipient user at the distribution terminal.

17. The computer implemented method of claim 16, wherein the at least one authentication credential is at least one of a unique string of numbers, a password, an image, or a quick response (QR) code.

18. The computer implemented method of claim 16, further comprising:
generating, by a sender user device, the data transmission request; and
transmitting, by the sender user device, the data transmission request to the distribution terminal associated with the geolocation identifier.

19. The computer implemented method of claim 16, further comprising:
transmitting the at least one authentication credential from a sender user device to a recipient user device associated with the recipient identifier.

20. The computer implemented method of claim 16, further comprising:
transmitting, from the distribution terminal, the image of the recipient user to a sender user device; and
receiving, from the sender user device and in response to the transmission of the image, an authentication indication of the recipient user, wherein the authentication indication comprises a positive authentication of the recipient user.
